(19) United States
(12) Patent Application Publication
(10) Pub. No.: US 2009/0148288 A1
(43) Pub. Date: Jun. 11, 2009

(54) VERTICAL FURLING FOR WIND TURBINES

(76) Inventors: Darryl Jessie, Saskatoon (CA); Dave A. Cote, Saskatoon (CA)

Correspondence Address: LAW OFFICES OF ALBERT WAI-KIT CHAN, PLLC, WORLD PLAZA, SUITE 604, 141-07 20TH AVENUE, WHITESTONE, NY, 11357, US

(21) Appl. No.: 12/330,005

(22) Filed: Dec. 8, 2008

(30) Foreign Application Priority Data
Dec. 7, 2007 (CA) 2,613,846

(51) Int. Cl. F03D 11/04

(52) U.S. Cl. 416/135

(57) ABSTRACT

A horizontal axis wind turbine apparatus includes a turbine assembly comprising a generator mounted in a housing, a rotor operative to rotate the generator in response to wind forces, and a tail extending rearward from the housing, and a base adapted to be mounted on a tower. The housing is pivotally attached to the base about a horizontal pivot axis oriented substantially perpendicular to a rotational axis of the generator and located rearward of a center of gravity of the turbine assembly such that the housing can pivot upward about the pivot axis from a lowered position to a raised position. A spring is operative to exert a downward bias force on the housing to urge the housing toward the lowered position.

This invention is in the field of wind turbines and in particular a furling mechanism to protect such turbines from damage when winds are excessive.

### BACKGROUND

All wind turbines have a maximum wind speed, commonly called the survival speed, above which they will not operate. The term “survival speed” commonly refers to the both the maximum wind speed and the maximum rotational speed of the turbine which are directly related to each other.

Wind turbines therefore require self-protection mechanisms to protect them from damage in extreme wind conditions. Some turbines have an internal brake and lock to prevent them from going faster than their maximum speed. Larger wind turbines include means to adjust the pitch of the blades so that as the wind speed increases the turbine speed can be controlled by changing the blade pitch.

Another mechanism commonly used to protect smaller wind turbines is a furling mechanism which operates to turn the blades of the turbine away from the wind so that the full force of the wind is no longer acting on the blades, so the turbine speed does not increase above the maximum speed.

A horizontal axis wind turbine includes a rotor with propeller type blades attached to a hub which in turn is attached to an electrical generator mounted in a housing. The axis of rotation is generally lowered with the blades extending generally perpendicular to the rotational axis and a tail is generally provided, sometimes formed by an extension of the housing, extending along the axis of rotation rearward from the housing opposite the rotor at the forward end of the housing. The housing is mounted to a tower about a vertical rotational axis so that the turbine can turn to expose the blades to the wind.

One type of furling mechanism is provided by an inclined upright pivot axis or hinge between the tail and the housing that provides a side furling action. The housing is mounted on a tower so that the horizontal rotational axis of the turbine is slightly offset from the vertical rotational axis. The wind against the rotor blades exerts a torque on the turbine about the vertical axis, and as the turbine rotates about the vertical axis in response to this torque the wind force moves the tail upward on the inclined hinge and the weight of the tail on the inclined hinge exerts an opposite torque tending to turn the turbine back into the wind. These opposite torques achieve a balance when wind speeds are acceptable, and then when wind speeds get too high, the torque exerted by the weight of the tail on the inclined hinge is not sufficient overcome the torque of the wind on the rotor, and the rotor turn away from the wind.

Generally this type of side furling mechanism does not allow the turbine to produce maximum power in the furled state, and in addition, towers for turbines that use this mechanism where the axes are offset are subject to additional asymmetric tower loads.

Another type of furling is vertical furling where the turbine housing is mounted on the tower about a horizontal pivot axis or hinge oriented substantially perpendicular to the turbine's rotational axis and below the rotational axis. The hinge is located near the rear of the housing so that the weight of the turbine and rotor keeps the hinge closed, with the housing resting on a base or the like so that the rotational axis of the turbine is substantially horizontal. The wind on the rotor exerts a force on the hinge tending to open the hinge and raise the turbine, however the weight of apparatus keeps the turbine rotational axis horizontal in acceptable wind speeds. As wind speed increases the force on the rotor increases until at some point the wind force overcomes the weight of the apparatus and the turbine and rotor pivot upward on the hinge, presenting the rotor at an angle to the wind and thereby reducing the wind force on the blades. Where the wind is fairly steady a balance can be achieved. Where the winds are variable and gusting however, the apparatus can move quite violently up and down about the horizontal hinge with rapid and impulsive motion at high speeds.

Southwest Windpower of Flagstaff, Ariz. for example builds a wind turbine that includes both the inclined upright hinge and the horizontal hinge to provide a combination of both vertical and side furling.

### SUMMARY OF THE INVENTION

It is an object of the present invention to provide a horizontal axis wind turbine apparatus with a furling mechanism that overcomes problems in the prior art. In a first embodiment the present invention provides a horizontal axis wind turbine apparatus. The apparatus comprises a turbine assembly comprising a generator rotatably mounted in a housing, a rotor attached to the generator at a front end thereof and operative to rotate the generator in response to wind forces on blades of the rotor, and a tail extending rearward from the housing, and a base adapted to be mounted on a tower. The housing is pivotally attached to the base about a substantially horizontal pivot axis oriented substantially perpendicular to a rotational axis of the generator and rotor and located rearward of a center of gravity of the turbine assembly such that the housing can pivot upward about the pivot axis from a lowered position, where the rotational axis of the generator and rotor is substantially horizontal, to a raised position. A spring is operative to exert a downward bias force on the housing to urge the housing toward the lowered position.

In a second embodiment the present invention provides a method of furling for a horizontal axis wind turbine assembly comprising a generator rotatably mounted in a housing, a rotor attached to the generator at a front end thereof and operative to rotate the generator in response to wind forces on blades of the rotor, and a tail extending rearward from the housing. The method comprises attaching a base on to a tower; pivotally attaching the housing to the base about a substantially horizontal pivot axis oriented substantially perpendicular to a rotational axis of the generator and rotor, and located rearward of a center of gravity of the turbine assembly, such that the housing can pivot upward about the pivot axis from a lowered position, where the rotational axis of the generator is substantially horizontal, to a raised position; providing a spring operative to exert a downward bias force on the housing to urge the housing toward the lowered position; configuring the turbine assembly and spring such that the housing remains in the lowered position at wind speeds below a furling speed, and such that when wind speeds exceed the furling speed, the housing pivots upward about the pivot axis against the spring bias force, and the spring bias force exerted by the spring increases as the housing pivots upward in response to increasing wind speeds.

The vertical furling of the prior art uses the weight of the turbine to bias the turbine down. As the turbine tilts up, the blades become angled to the wind, reducing the force on the turbine so that the turbine stops moving up. However as the turbine moves up, the blades move up and the wind exerts the force on the turbine farther above the hinge, increasing the moment arm, such that even though the wind force is reduced, the longer moment arm can result in greater torque. In addition, when the turbine pivots upward about the hinge, the center of gravity moves rearward, decreasing the moment arm through which the weight of the turbine resists the upward torque of the wind.

Thus once the wind force required to initially raise the turbine up from the horizontal is attained, the forces tending to resist this movement are reduced. The forces resulting from the geometry of the arrangement vary dramatically and balance becomes difficult to achieve, even in relatively steady winds.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a side view of an embodiment of the apparatus of the present invention where the spring is provided by a U-shaped leaf spring shown in the lowered position;

FIG. 2 is a detail side view of the leaf spring of the embodiment of FIG. 1 in the lowered position;

FIG. 3 is a side view of the embodiment of FIG. 1 shown in a raised position;

FIG. 4 is a detail side view of the leaf spring of the embodiment of FIG. 1 in the raised position of FIG. 3;

FIG. 5 is a schematic illustration of the operation of a prior art furling mechanism showing the weight of the apparatus keeping the apparatus in the lowered position as shown;

FIG. 6 is a schematic illustration of the forces acting on the furling mechanism of FIG. 5 when the apparatus is in a raised position;

FIG. 7 is a graph of the rotational speed of the generator and rotor of one embodiment of an apparatus of the invention against wind speed, and also showing the furling angle against wind speed;

FIG. 8 illustrates an alternate horizontal axis wind turbine apparatus where the housing is pivotally attached to the base by a hinge and the spring is provided by a torsion spring shown; the turbine is shown in a raised position;

FIG. 9 is a detail side view of the hinge and torsion spring of the embodiment of FIG. 8 in the raised position of FIG. 8.

### DETAILED DESCRIPTION OF THE ILLUSTRATED EMBODIMENTS

FIGS. 1-4 schematically illustrate an embodiment of a horizontal axis wind turbine apparatus 1 of the present invention. The apparatus 1 comprises a turbine assembly 3 comprising a generator rotatably mounted in a housing 5, a rotor 7 attached to the generator at a front end thereof and operative to rotate the generator in response to wind forces on blades 9 of the rotor; and a tail 11 extending rearward from the housing 5. The generator is located inside the housing 5 as is known in the art, and is not illustrated.

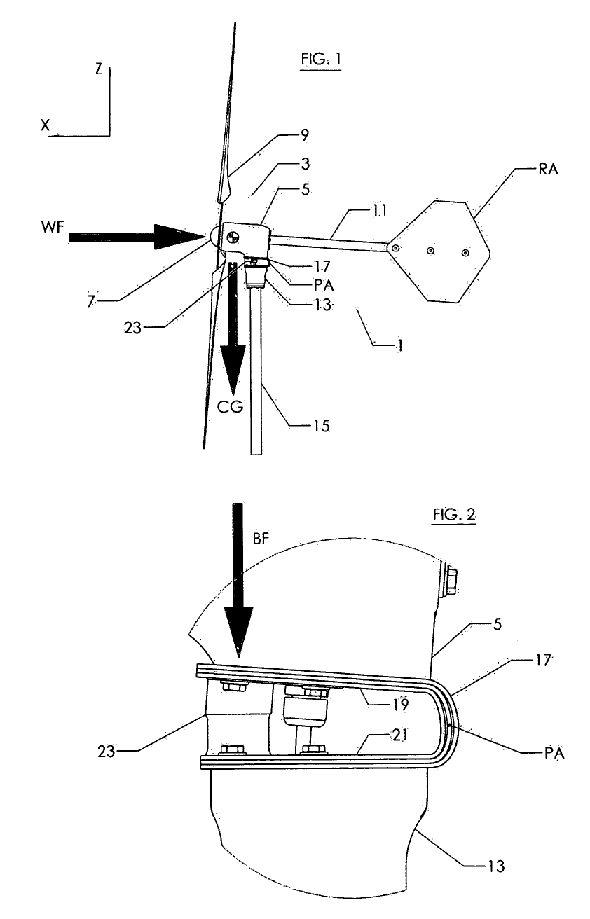

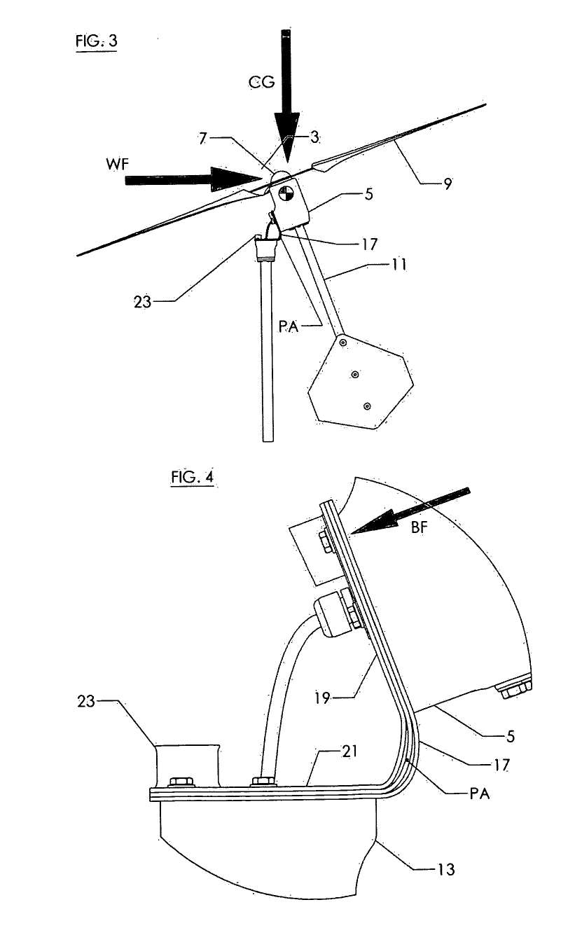

A base 13 is adapted to be mounted on a tower 15 to support the turbine assembly 3 in an elevated position exposed to the wind. The housing 5 is pivotally attached to the base 13 about a substantially horizontal pivot axis PA oriented substantially perpendicular to a rotational axis RA of the generator and rotor 7 and located rearward of a center of gravity CG of the turbine assembly 3 such that the housing 5 can pivot upward about the pivot axis PA from the generally lowered position shown in FIGS. 1 and 2, where the rotational axis RA of the generator and rotor 7 is substantially horizontal, to the raised position of FIG. 3 where the housing 5 has pivoted upward about the pivot axis PA to the illustrated raised position that is about seventy degrees above the lowered position. As can be seen the rotational axis RA is slightly above horizontal when in the lowered position as is common in such horizontal axis wind turbines. This slight upward tilt moves the blades 9 on the bottom of the rotor away from the tower 15 to reduce the chance that the blades might flex and contact the tower.

A spring 17 is operative to exert a downward bias force BF on the housing 5 to urge the housing 5 toward the lowered position of FIG. 1. The illustrated spring comprises a U-shaped leaf spring 17 configured such that an upper leg 19 of the U is attached to the housing 5 and a lower leg 21 of the U is attached to the base 13. A housing support member 23 on the base, and illustrated as attached to the base by attachment to the lower leg 21 of the U-shaped leaf spring 17, is configured such that the housing 5 rests on the housing support member 23 when the housing 5 is in the lowered position of FIGS. 1 and 2.

The spring 17 can be configured to exert the downward bias force BF only when the housing 5 moves up from the lowered position of FIGS. 1 and 2 such that the bias force BF is substantially zero when in the lowered position of FIGS. 1 and 2, and then only when the housing 5 pivots up from the lowered position does the spring 17 begin to exert the downward bias force BF. Thus if the at rest position of the U shaped leaf spring 17 is as illustrated in FIGS. 1 and 2 where the legs 19, 21 are parallel, then substantially no bias force will be exerted until the legs 19, 21 are moved apart, as when the housing tilts upward about the pivot axis PA.

In this configuration, only the weight of the turbine assembly 3 acting at the center of gravity CG would keep the housing 5 in the lowered position during lower wind speeds below a furling speed at which the wind force WF, acting substantially at the center of the rotor 7, is sufficiently strong to begin to lift the housing off the support member 23 and upward to a raised position above the lowered position. Then as the housing 5 moves upward, the spring 17 extends. The bias force BF exerted by the spring 17 is proportional to the distance the spring 17 is extended, and so it can be seen that the bias force increases as the housing 5 pivots upward in response to increasing wind speeds and increasing wind force WF.

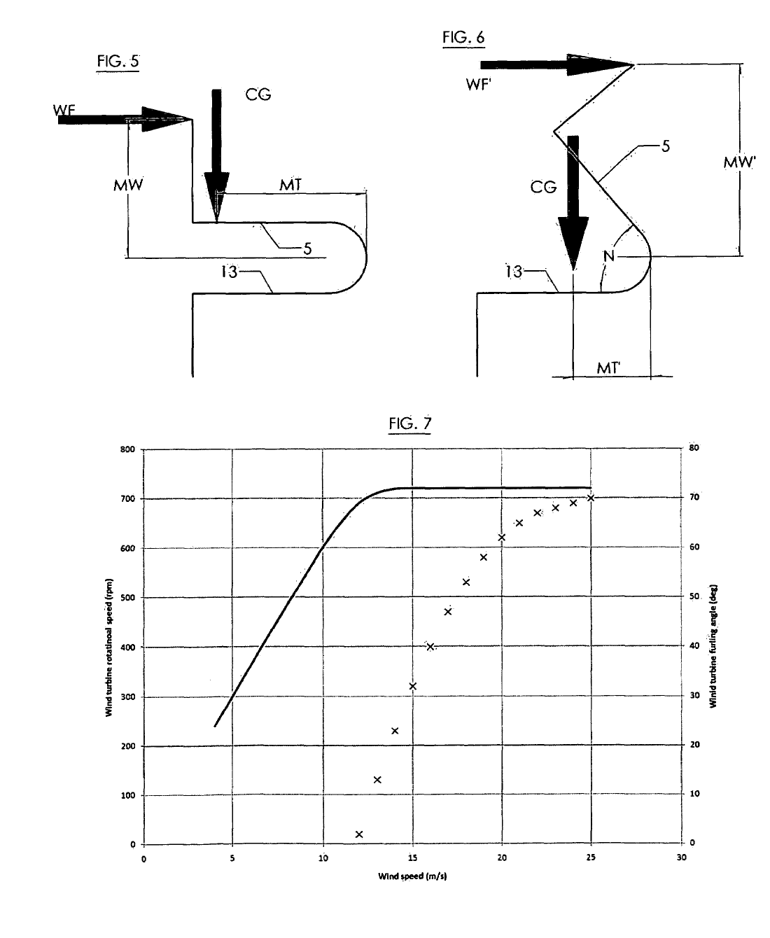

This is in contrast to the prior art vertical furling where, as schematically illustrated in FIGS. 5 and 6, the effective downward force exerted by the weight of the turbine assembly at the center of gravity CG decreases as the housing 5 pivots upward. In FIG. 5 the housing 5 is in the lowered position and the center of gravity CG of the turbine assembly acts through a moment arm having a horizontal length MT from the pivot axis PA, creating essentially a torque resisting upward movement that is equal to the weight at CG times the moment arm MT. When the housing 5 moves upward the geometry of the arrangement causes the horizontal moment arm of the center of gravity CO to get shorter. For example when the housing is inclined upward at 60 degrees as shown in FIG. 6, the horizontal moment arm of the center of gravity CG reduces to MT′. Since the weight at the center of gravity remains constant, the torque resisting upward movement of the housing 5 is reduced.

FIGS. 5 and 6 also illustrate that while tilting the rotor 7 to an angle with respect to the wind reduces the wind force exerted on the rotor from WF in FIG. 5 to a lesser amount WF′ in FIG. 6, the effective force urging the turbine assembly upward may not be reduced. The wind force exerts a torque in the same manner as described above for the weight of the turbine assembly, but in the opposite direction urging the turbine assembly to pivot upward. As the housing 5 rises, the moment arm about which the wind exerts torque about the pivot axis PA increases from MW in FIG. 5 to a greater length MW′ in FIG. 6. So even if the actual force is reduced from WF to WF′, the torque will not be reduced by the same amount, and in fact may actually increase.

Thus in the prior art the pivoting torque exerted by the wind can remain the same while the resisting torque of the weight of the turbine assembly decreases as the wind speed increases, making it difficult for the apparatus 1 to achieve a balance. The spring bias mechanism of the present invention provides an apparatus that is more stable, since there is at all times increasing resistance to upward movement of the housing, and balance can be attained.

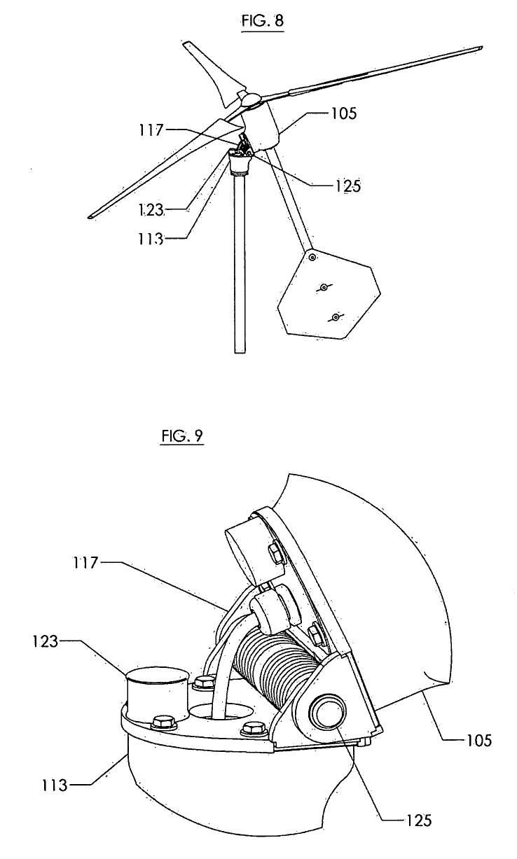

FIG. 7 illustrates, for one wind turbine apparatus built according to the present invention, a solid line showing the rotational speed of the generator and rotor 7 against wind speed. Also shown with “x” is the furling angle N, as shown in FIG. 6, against wind speed. As can be seen the rotational speed of the turbine increases as wind speed increases from about 4 meters per second (m/s) to about 12 m/s, which in this example is the furling wind speed at which the housing begins to move up from the lowered position. As the wind speed increases above the furling speed, the rotational speed of the turbine stays substantially constant at about 725 revolutions per minute (rpm) until the wind speed reaches about 25 m/s, or about 90 kilometres per hour (kph), at which point the turbine had risen to the maximum furling angle of 70 degrees. Above this wind speed, the furling angle remains at 70 degrees, and the rotational speed of the turbine increases further. The maximum furling can vary depending on the application. Thus a designed survival speed of the turbine should be one that will withstand the highest winds contemplated in a location.

It is contemplated that the spring 17 could also could be preloaded such that a downward bias force BF is exerted when the housing 5 is in the lowered position. Thus if the at rest position of the U shaped leaf spring 17 illustrated in FIGS. 1 and 2 is a position where the legs 19, 21 are angled toward each other, then a bias force will be exerted when the legs 19, 21 are moved apart to the parallel position of FIGS. 1 and 2, and the bias force BF will increase as when the housing tilts upward about the pivot axis PA.

By varying the spring constant and configuration of the spring 17, considerable versatility can be achieved to provide for a variety of conditions and turbine configurations.

FIGS. 8 and 9 illustrate an alternate horizontal axis wind turbine apparatus 101 in a raised and furled position. In this embodiment, the housing 105 is pivotally mounted to the base 113 by a hinge 125, and wherein the spring 117 comprises a torsion spring 117 mounted in the hinge 125. A housing support member 123 on the base 113 is configured such that the housing 105 rests on the housing support member 123 when in the lowered position.

The invention also provides a method of furling for a horizontal axis wind turbine assembly 3 comprising a generator rotatably mounted in a housing 5, a rotor 7 attached to the generator at a front end thereof and operative to rotate the generator in response to wind forces on blades 9 of the rotor 7, and a tail 11 extending rearward from the housing 5. The method comprises attaching a base 13 on to a tower 15 and pivotally attaching the housing 5 of the turbine assembly 3 to the base 13 about a substantially horizontal pivot axis PA oriented substantially perpendicular to a rotational axis of the generator and rotor 7, and located rearward of a center of gravity of the turbine assembly 3, such that the housing 5 can pivot upward about the pivot axis PA from a lowered position illustrated in FIG. 1, where the rotational axis RA of the generator is substantially horizontal, to a raised position. A spring is provided operative to exert a downward bias force BF on the housing 5 to urge the housing 5 toward the lowered position. The turbine assembly 3 and spring 17 are configured such that the housing 5 remains in the lowered position at wind speeds below a furling speed, and such that when wind speeds exceed the furling speed, the housing 5 pivots upward about the pivot axis PA against the spring bias force BF, and the spring bias force BF exerted by the spring 17 increases as the housing 5 pivots upward in response to increasing wind speeds.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A horizontal axis wind turbine apparatus comprising:
a turbine assembly comprising a generator rotatably mounted in a housing; a rotor attached to the generator at a front end thereof and operative to rotate the generator in response to wind forces on blades of the rotor; and a tail extending rearward from the housing;
a base adapted to be mounted on a tower;
wherein the housing is pivotally attached to the base about a substantially horizontal pivot axis oriented substantially perpendicular to a rotational axis of the generator and rotor and located rearward of a center of gravity of the turbine assembly such that the housing can pivot upward about the pivot axis from a lowered position, where the rotational axis of the generator and rotor is substantially horizontal, to a raised position; and
a spring operative to exert a downward bias force on the housing to urge the housing toward the lowered position.

2. The apparatus of claim 1 wherein the spring comprises a U-shaped leaf spring configured such that an upper leg of the U is attached to the housing and a lower leg of the U is attached to the base.

3. The apparatus of claim 2 comprising a housing support member configured such that the housing rests on the housing support member when the housing is in the lowered position.

4. The apparatus of claim 1 wherein the housing is pivotally mounted to the base by a hinge, and wherein the spring comprises a torsion spring mounted in the hinge.

5. The apparatus of claim 4 comprising a housing support member configured such that the housing rests on the housing support member when in the lowered position.

6. The apparatus of claim 1 configured such that the housing can pivot upward about the pivot axis to a raised position that is about seventy degrees above the lowered position.

7. The apparatus of claim 1 wherein the spring is configured to exert a downward bias force on the housing when the housing is in the lowered position.

8. The apparatus of claim 1 wherein the spring is configured to exert a downward bias force on the housing only when the housing moves up from the lowered position.

9. A method of furling for a horizontal axis wind turbine assembly comprising a generator rotatably mounted in a housing, a rotor attached to the generator at a front end thereof and operative to rotate the generator in response to wind forces on blades of the rotor, and a tail extending rearward from the housing, the method comprising:
attaching a base on to a tower;
pivotally attaching the housing to the base about a substantially horizontal pivot axis oriented substantially perpendicular to a rotational axis of the generator and rotor, and located rearward of a center of gravity of the turbine assembly, such that the housing can pivot upward about the pivot axis from a lowered position, where the rotational axis of the generator is substantially horizontal, to a raised position;
providing a spring operative to exert a downward bias force on the housing to urge the housing toward the lowered position;
configuring the turbine assembly and spring such that the housing remains in the lowered position at wind speeds below a furling speed, and such that when wind speeds exceed the furling speed, the housing pivots upward about the pivot axis against the spring bias force, and the spring bias force exerted by the spring increases as the housing pivots upward in response to increasing wind speeds.

10. The method of claim 9 wherein the spring comprises a U-shaped leaf spring configured such that an upper leg of the U is attached to the housing and a lower leg of the U is attached to the base.

11. The method of claim 10 comprising a housing support member configured such that the housing rests on the housing support member when the housing is in the lowered position.

12. The method of claim 9 wherein the housing is pivotally mounted to the base by a hinge, and wherein the spring comprises a torsion spring mounted in the hinge.

13. The method of claim 12 comprising a housing support member configured such that the housing rests on the housing support member when in the lowered position.

14. The method of claim 9 comprising configuring the spring such that the housing can pivot upward about the pivot axis to a raised position that is about seventy degrees above the lowered position.

15. The method of claim 9 wherein the spring is configured to exert a downward bias force on the housing when the housing is in the lowered position.

16. The method of claim 9 wherein the spring is configured to exert a downward bias force on the housing only when the housing moves up from the lowered position.
